(19) United States
(12) Patent Application Publication
(10) Pub. No.: US 2004/0014836 A1
(43) Pub. Date: Jan. 22, 2004

(54) Silicone-containing polymers of ethylenically unsaturated monomers

(75) Inventors: Hans-Peter Weitzel, Reischach (DE); Wolfgang Keller, Mehring (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Polymer Systems GmbH & Co. KG, Burghauen (DE)

(21) Appl. No.: 10/449,374

(22) Filed: May 30, 2003

(30) Foreign Application Priority Data
Jul. 19, 2002 (DE) 102 32 993.1

(51) Int. Cl. C08G 2/00

(52) U.S. Cl. 522/99

(57) ABSTRACT

Silicone-containing addition polymers are obtained by free-radically initiated polymerization of ethylenically unsaturated monomers, wherein the polymerization is initiated using an organopolysiloxane which contains at least one peroxide group —OOR′ in which R′ is a hydrogen atom, or a monovalent C₁ to C₁₈ hydrocarbon radical or C₁ to C₁₈ acyl radical each of which may be substituted by cyano-, fluoro-, chloro-, bromo- or organopolysiloxane and each of which may be interrupted by divalent radicals attached on both sides to carbon atoms and selected from the group consisting of —O—, —COO—, —OOC—, —CONR³—, —NR³CO—, and —CO—, where R³ is hydrogen or an optionally cyano-, fluoro-, chloro- or bromo-substituted C₁ to C₁₀ hydrocarbon radical.

### BACKGROUND OF THE INVENTION

1. Field of the Invention

The invention relates to silicone-containing polymers of ethylenically unsaturated monomers, to processes for preparing them, and to their use.

2. Background Art

Solid organic polymer resins frequently tend toward blocking. It is known that silicones have good release properties; that is, have a surface which repels tacky substances. Blends of solid vinyl ester resins with silicones, however, have unsatisfactory properties. Owing to the incompatibility of vinyl ester polymers and silicones, phase separation occurs and/or silicone domains develop, and hence the solid resins become turbid. The development of silicone domains and the presence of unattached silicone, moreover, lead to migration effects.

WO-A 01/85685 discloses graft polymerization with siloxane macromonomers: that is, the reaction of polysiloxanes having one or more unsaturated groups and/or mercapto-functional polysiloxanes, the latter of which react with ethylenically unsaturated monomers via the SH group. A disadvantage is the incompatibility between the silicone phase and the polymer phase. EP-A 493168 discloses hydrophobicizing addition polymers by blending their aqueous dispersions with silicones and then drying the blends. WO-A 95/20627 describes the blending of aqueous polymer dispersions with, inter alia, oligosiloxanes, silanes or polysilanes and subsequently drying the blends to provide hydrophobicized addition polymers. U.S. Pat. No. 3,203,919 describes the preparation of coating compositions by mixing a polymer dispersion and a polysiloxane dispersion. A disadvantage of these procedures is the problem of the incompatibility between the organic polymer phase and the silicone phase, frequently leading to products which lack homogeneity.

In order to eliminate this incompatibility problem, WO-A 95/20626 proposes avoiding subsequently mixing the silicone component into the organic polymer, but rather adding the silicone during the actual polymerization. A disadvantage here is that in many cases the copolymerization of the ethylenically unsaturated monomers is hindered, and thus the polymerization is slowed and/or the product quality is unsatisfactory.

### SUMMARY OF THE INVENTION

It was therefore an object of the invention to provide silicone-modified polymers of ethylenically unsaturated monomers which do not have the abovementioned disadvantages. This and other objects are achieved by employing as a polymerization initiator in the polymerization of unsaturated monomers, an organopolysiloxane bearing a peroxide or hydroperoxide moiety.

### DETAILED DESCRIPTION OF THE PREFERRED EMBODIMENT(S)

The invention thus provides silicone-containing polymers of ethylenically unsaturated monomers, obtainable by free-radically initiated polymerization of ethylenically unsaturated monomers, wherein the polymerization is initiated using an organopolysiloxane which contains at least one peroxide group —OOR¹ in which R¹ is a hydrogen atom, or a monovalent C₁ to C₁₈ hydrocarbon radical or C₁ to C₁₈ acyl radical each of which may be substituted by cyano-, fluoro-, chloro-, bromo- or organopolysiloxane and each of which may be interrupted by divalent radicals attached on both sides to carbon atoms and selected from the group consisting of —O—, —COO—, —OOC—, —CONR³—, —NR³CO—, and —CO—, R³ being hydrogen or an optionally cyano-, fluoro-, chloro- or bromo-substituted C₁ to C₁₀ hydrocarbon radical.

R¹ is preferably a hydrogen atom or a monovalent C₁ to C₄ hydrocarbon radical; with particular preference, R¹ is H.

Suitable peroxide-functional organopolysiloxanes (P) include those having at least one unit of the general formula (I)

YₐR_{b}SiO_{4-a-b/2} (I)

where Y is a group of the general formula

-A-CR²₂—OO—R¹ (II)

where

R is a hydrogen atom, a C₁ to C₁₂ alkoxy, hydroxyl or alkylglycol radical or monovalent, optionally cyano-, fluoro-, chloro- or bromo-substituted C₁ to C₁₈ hydrocarbon radical which may be interrupted by divalent radicals attached on both sides to carbon atoms and selected from the group consisting of —O—, —COO—, —OOC—, —CONR³—, —NR³CO— and —CO—, and A is a chemical bond or a divalent, optionally cyano-, fluoro-, chloro- or bromo-substituted C₁ to C₁₈ hydrocarbon radical, preferably an alkylene radical, and

R¹ is a hydrogen atom, or a monovalent C₁ to C₁₈ hydrocarbon radical or C₁ to C₁₈ acyl radical each of which may be substituted by cyano-, fluoro-, chloro-, bromo- or organopolysiloxane and each of which may be interrupted by divalent radicals attached on both sides to carbon atoms and selected from the group consisting of —O—, —COO—, —OOC—, —CONR³—, —NR³CO— and —CO—,

R² is an optionally cyano-, fluoro-, chloro- or bromo-substituted C₁ to C₁₀ hydrocarbon radical,

R³ is defined as hydrogen or R²,

and where a=1, 2 or 3, b=0, 1 or 2,

and a+b=1, 2 or 3.

Examples of unsubstituted radicals R and R¹ are alkyl radicals such as the methyl and ethyl radicals; cycloalkyl radicals such as the cyclohexyl radical; aryl radicals such as the phenyl, biphenylyl, naphthyl, anthryl and phenanthryl radicals; alkaryl radicals such as the o-, m-, and p-tolyl radicals, the xylyl radical, and the ethylphenyl radical; aralkyl radicals, such as the benzyl radical, and the α- and the β-phenylethyl radicals. Examples of substituted hydrocarbon radicals R and R¹ are halogenated hydrocarbon radicals, epoxyalkyl radicals, (meth)acryloyloxyalkyl radicals, cyanoalkyl radicals, aminoalkyl radicals, aminoaryl radicals, quaternary ammonium radicals, and hydroxyalkyl radicals.

The alkoxy radicals R include the previously described alkyl radicals bonded to the respective moiety by an oxygen atom. The examples of alkyl radicals R apply fully to the alkoxy radicals as well. The radical R preferably comprises substituted and unsubstituted C₁ to C₁₈ alkyl radicals, hydrogen, and the phenyl radical, in particular the methyl, ethyl, propyl, octyl, hexyl, dodecyl, octadecyl, phenyl, vinyl, allyl, methacryloyloxypropyl, 3-chloropropyl, 3-mercaptopropyl, 3-hydroxypropyl, 3-(2,3-dihydroxypropoxy)propyl, 3-aminopropyl, and (2-aminoethyl)-3-aminopropyl radicals, hydrogen, and quaternary ammonium radicals.

The radical R¹ preferably comprises hydrogen, substituted or unsubstituted C₁ to C₁₈ alkyl radicals, especially the tert-butyl, isopropyl, octyl, hexyl, dodecyl, and octadecyl radicals. The radical R² preferably comprises substituted and unsubstituted C₁ to C₆ alkyl radicals, in particular the methyl, ethyl, and propyl radicals.

Examples of divalent hydrocarbon radicals A are saturated alkylene radicals such as the methylene and ethylene radical, and also propylene, butylene, pentylene, hexylene, cyclohexylene, and octadecylene radicals, or unsaturated alkylene or arylene radicals such as the hexenylene radical and phenylene radicals, especially linear C₁ to C₆ alkylene radicals. Divalent hydrocarbon radical A is most preferably the ethylene radical.

In addition to the units of the general formula (I) the organopolysiloxane (P) may contain further siloxane units, preferably those of the general formulae

[R₃SiO_{1/2}] (III),

[R₂SiO_{2/2}] (IV),

[RSiO_{3/2}] (V),

[SiO_{4/2}] (VI),

in which R has the above definitions.

The organopolysiloxane (P) preferably contains

1 to 100.0 mol % of units of the general formula (I),

0 to 50.0 mol % of units of the general formula (III),

0 to 90.0 mol % of units of the general formula (IV),

0 to 50.0 mol % of units of the general formula (V),

0 to 50.0 mol % of units of the general formula (VI).

The organopolysiloxane (P) more preferably contains

1 to 50.0 mol % of units of the general formula (I),

0 to 40.0 mol % of units of the general formula (III),

10 to 80.0 mol % of units of the general formula (IV),

0 to 10.0 mol % of units of the general formula (V),

0 to 10.0 mol % of units of the general formula (VI).

The organopolysiloxane (P) can be in the form of a linear or cyclic molecule, with the peroxy groups attached in comblike manner or at the chain end. The organopolysiloxane (P) may also be in branched or crosslinked form.

The organopolysiloxane (P) contains in total at least 2, preferably at least 3, units, more preferably from 20 to 40 units, of the general formulae (I) and (III) to (VI). The molar ratio of the siloxane units carrying the peroxide group —OOR¹ to the remaining siloxane units is preferably from 1:10 to 1:1. Preference is also given to organopolysiloxanes containing terminal peroxide groups —OOR¹. Particular preference is given to organopolydialkylsiloxanes, especially polydimethylsiloxanes, having peroxide units attached via alkylene units, in the chain or terminally at the chain end. The organopolysiloxane may be solid or liquid at 25° C. The viscosity at 25° C. is preferably not more than 100 Pas, more preferably not more than 10 Pas, and most preferably not more than 2 Pas.

The peroxide-functional organopolysiloxane (P) containing at least one unit of the above general formula (I) can be prepared by reacting an organopolysiloxane (B) containing at least one unit of the general formula ZₐR_{b}SiO_{4-a-b/2} (VII), in which Z is a group of the general formula -A-CR²₂—OH (VIII) or in which Z is a group of the general formula -A-CR²═CH₂ (IX), with H₂O₂, where R, R², a, and b are as defined above, yielding an organopolysiloxane (P) in which R¹ is a hydrogen atom.

The organopolysiloxane of the general formula (VII) containing the radical of the general formula (VIII) can be prepared, for example, by transition-metal-catalyzed reaction of unsaturated tertiary alcohols with polysiloxanes containing SiH bonds (hydrosilylation), such as 2-methyl-3-buten-2-ol, 2-hydroxy-2,5-dimethyl-5-hexene, or H₂C═CMe—Ph—CMe₂OH. These examples are illustrative and not limiting.

The organopolysiloxane of the general formula (VII) containing the radical of the general formula (IX) can be prepared, for example, by transition-metal-catalyzed reaction of such an excess of diunsaturated compounds containing 2-propenyl groups with polysiloxanes containing SiH bonds (hydrosilylation), for example, 2,5-dimethyl-1,5-hexadiene, or H₂C═CMe—Ph—CMe═CH₂, that on average only one of the double bonds is consumed in the reaction.

The organopolysiloxane of the general formula (VII) containing the radical of the general formula (IX) can likewise be prepared by Si—C coupling reactions using organometallic reagents, for example, by reacting polysiloxanes containing SiCl groups with Grignard reagents of the formula H₂C═CMe—MgCl or H₂C═CMe—CH₂MgCl, or with other organometallic coupling reagents.

Organopolysiloxanes (P) wherein R¹ is a monovalent C₁ to C₁₈ hydrocarbon radical or C₁ to C₁₈ acyl radical each of which may be substituted by cyano-, fluoro-, chloro-, bromo- or organopolysiloxane and each of which may be interrupted by divalent radicals attached on both sides to carbon atoms selected from the group consisting of —O—, —COO—, —OOC—, —CONR³—, —NR³CO— and —CO—, are prepared by reacting organopolysiloxane (P) in which R¹ is a hydrogen atom with compounds of the general formula XR¹ (X), where R¹ is a monovalent C₁ to C₁₈ hydrocarbon radical or C₁ to C₁₈ acyl radical each of which may be substituted by cyano-, fluoro-, chloro-, bromo- or organopolysiloxane and each of which may be interrupted by divalent radicals attached on both sides to carbon atoms and selected from the group consisting of —O—, —COO—, —OOC—, —CONR³—, —NR³CO— and —CO—, where X is fluoro, chloro, bromo, hydroxyl, hydrogen or an acid anhydride radical.

If X is hydrogen the reaction can take place, for example, in the presence of CuCl. If X is fluoro, chloro or bromo the reaction can take place, for example, in the presence of dicyclohexylcarbodiimide. If R¹ is acyl radical and X is acid anhydride radical the reaction can take place, for example, in the presence of CuCl.

The reaction of organopolysiloxane (B) with H₂O₂ preferably takes place under acid catalysis. Strong acids such as sulfuric acid are preferred. The reaction of organopolysiloxane (B) with H₂O₂ preferably takes place in a solution or dispersion of the organopolysiloxane (B). It is preferred to use alcohols or similar polar solvents. The reaction of organopolysiloxane (B) with H₂O₂ preferably takes place at from 20 to 100° C.

Organopolysiloxanes (B) are known per se. They can be prepared, for example, by subjecting aliphatically unsaturated tertiary alcohols to an addition reaction with organopolysiloxanes containing SiH groups.

Suitable ethylenically unsaturated monomers include vinyl esters of branched or unbranched alkylcarboxylic acids having 1 to 18 carbon atoms; acrylic esters or methacrylic esters of branched or unbranched C₁₋₁₈ alcohols or C₂₋₁₈ diols; ethylenically unsaturated monocarboxylic and dicarboxylic acids, their amides, N-methylolamides, and/or nitriles; ethylenically unsaturated sulfonic acids; ethylenically unsaturated heterocyclic compounds; dienes; olefins; vinylaromatics; and vinyl halides. This list is not limiting, and includes all unsaturated monomers susceptible to free-radical induced polymerization.

Suitable vinyl esters include those of carboxylic acids having 1 to 12 carbon atoms. Preference is given to vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 13 carbon atoms, such as VeoVa^{R}9 or VeoVa^{R}10 (trade names of Resolution). Particular preference is given to vinyl acetate.

Suitable monomers from the acrylic ester or methacrylic ester group include esters of branched or unbranched alcohols having 1 to 15 carbon atoms. Preferred (meth)acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, and 2-ethylhexyl acrylate. Particular preference is given to methyl acrylate, methyl methacrylate, n-butyl acrylate, t-butyl acrylate, and 2-ethylhexyl acrylate.

Examples of suitable ethylenically unsaturated monocarboxylic and dicarboxylic acids, their amides, N-methylolamides and/or nitriles, are acrylic acid, methacrylic acid, fumaric acid, maleic acid, acrylamide, N-methylolacrylamide, N-methylolmethacrylamide, and acrylonitrile. Examples of ethylenically unsaturated sulfonic acids are vinylsulfonic acid and 2-acrylamido-2-methylpropanesulfonic acid. Suitable ethylenically unsaturated heterocyclic compounds include vinylpyrrolidone and vinylpyridine.

Preferred vinylaromatics are styrene, methylstyrene, and vinyltoluene. A preferred vinyl halide is vinyl chloride. The preferred olefins are ethylene and propylene, and the preferred dienes are 1,3-butadiene and isoprene.

If desired it is also possible to copolymerize from 0.1 to 50% by weight, based on the total weight of the monomer mixture, of auxiliary monomers, preferably from 0.5 to 15% by weight. Examples of auxiliary monomers include ethylenically unsaturated monocarboxylic and dicarboxylic acids, preferably acrylic acid, methacrylic acid, fumaric acid, and maleic acid; ethylenically unsaturated carboxamides and carbonitriles, preferably acrylamide and acrylonitrile; monoesters and diesters of fumaric acid and maleic acid such as the diethyl and diisopropyl esters; maleic anhydride; ethylenically unsaturated sulfonic acids and their salts, preferably vinylsulfonic acid and 2-acrylamido-2-methylpropanesulfonic acid. Further examples are precrosslinking comonomers such as polyethylenically unsaturated comonomers, examples being divinyl adipate, diallyl maleate, diallyl phthalate, allyl methacrylate, and triallyl cyanurate, or postcrosslinking comonomers, examples being acrylamidoglycolic acid (AGA), methacrylamidoglycolic acid methyl ester (MAGME), N-methylolacrylamide (NMA), N-methylolmethacrylamide, N-methylolallylcarbamate, alkyl ethers and esters such as the isobutoxy ether or ester of N-methylolacrylamide, of N-methylolmethacrylamide, and of N-methylolallylcarbamate. Also suitable are epoxide-functional comonomers such as glycidyl methacrylate and glycidyl acrylate. Further examples are silicon-functional comonomers such as acryloyloxypropyltri(alkoxy)silanes and methacryloyloxypropyltri(alkoxy)silanes, vinyltrialkoxysilanes, and vinylmethyldialkoxysilanes, preferred examples of alkoxy groups including ethoxy and ethoxypropylene glycol ether radicals. Mention may also be made of monomers containing hydroxyl or CO groups, examples being (meth)acrylic acid hydroxyalkyl esters such as hydroxyethyl, hydroxypropyl or hydroxybutyl (meth)acrylate, and compounds such as diacetoneacrylamide and acetylacetoxyethyl (meth)acrylate. Also suitable are amino-functional comonomers such as 2-dimethylaminoethyl methacrylate, 3-dimethylaminopropylmethacrylamide, 2-trimethylammoniomethyl methacrylate chloride, and 3-trimethylammoniopropylmethacrylamide chloride.

Particular preference is given to monomers or monomer mixtures including one or more monomers selected from the group consisting of vinyl acetate, vinyl esters of α-branched monocarboxylic acids having 9 to 13 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, and styrene. Most preferred are mixtures of vinyl acetate with ethylene; of vinyl acetate, ethylene, and a vinyl ester of α-branched monocarboxylic acids having 9 to 13 carbon atoms; of n-butyl acrylate with 2-ethylhexyl acrylate and/or methyl methacrylate; of styrene with one or more methyl acrylate, ethyl acrylate, propyl acrylate, n-butyl acrylate, and 2-ethylhexyl acrylate; and of vinyl acetate with one or more of methyl acrylate, ethyl acrylate, propyl acrylate, n-butyl acrylate, 2-ethylhexyl acrylate, and, if desired, ethylene. These mixtures may optionally contain one or more of the abovementioned auxiliary monomers as well as the principle monomers.

The monomer selection or the selection of the weight fractions of the comonomers is generally made such that a glass transition temperature, Tg, of −50° C. to +120° C., preferably −30° C. to +95° C., is obtained. The glass transition temperature Tg of the polymers can be determined in a known manner by means of differential scanning calorimetry (DSC). The Tg can also be calculated approximately in advance by means of the Fox equation. According to T. G. Fox, BULL. AM. PHYSICS SOC. 1, 3, page 123 (1956), 1/Tg=x₁/Tg₁+x₂/Tg₂+ . . . +xₙ/Tgₙ, where xₙ stands for the mass fraction (% by weight/100) of the monomer n and Tgₙ is the glass transition temperature in degrees Kelvin of the homopolymer of the monomer n. Tg values for homopolymers are listed in the POLYMER HANDBOOK 2nd Edition, J. Wiley & Sons, New York (1975).

The free-radically initiated polymerization of the ethylenically unsaturated monomers may in principle take place by any of the polymerization techniques used for this purpose, such as bulk polymerization, solution polymerization, precipitation polymerization, suspension polymerization, emulsion polymerization, and mini-emulsion polymerization. Preference is given to mini-emulsion polymerization, which is distinguished by the conversion of water, emulsifier, and monomer components into a finely divided emulsion preferably with a mean particle size of 100 to 500 nm, by exposure to a dispersing force, preferably a shearing force. This emulsion is then converted by polymerization into a dispersion of approximately the same particle size. This procedure, which is known to one skilled in the art, is employed especially advantageously when using components having very low or no solubility in water. See, e.g., El-Aasser et al., MACROMOL.SYMP. 92, 157-168 (1995)).

The polymerization temperature is generally from 40° C. to 100° C., preferably from 60° C. to 90° C. In the case of the copolymerization of gaseous comonomers such as ethylene, 1,3-butadiene or vinyl chloride it is also possible to operate under pressure, generally at between 5 bar and 100 bar.

The polymerization is initiated employing the peroxide-functional organopolysiloxanes, preferably in an amount from 5 to 95% by weight, more preferably 20 to 80% by weight, based in each case on the total weight of the monomers. The peroxide-functional organopolysiloxanes are preferably used as redox initiators, in combination with reducing agents. Suitable reducing agents are the sulfites and bisulfites of the alkali metals and of ammonium, such as sodium sulfite, the derivatives of sulfoxylic acid such as zinc or alkali metal formaldehydesulfoxylates, an example being sodium hydroxymethanesulfinate, ascorbic acid, polyvalent amines such as (trisaminoethyl)amine, diethylenetriamine, and metal ions which occur in two or more oxidation states, such as Fe(II) and Co(II). The amount of reducing agent is generally 0.01 to 10.0% by weight, preferably 0.1 to 0.5% by weight, based in each case on the total weight of the monomers.

The techniques of suspension and emulsion polymerization and also the preferred mini-emulsion polymerization are carried out in the presence of surface-active substances such as protective colloids and/or emulsifiers. Examples of suitable protective colloids include partially hydrolyzed polyvinyl alcohols, polyvinylpyrrolidones, polyvinyl acetals, and starches and celluloses and their carboxymethyl, methyl, hydroxyethyl, and hydroxypropyl derivatives. Suitable emulsifiers include anionic, cationic, and nonionic emulsifiers, examples being anionic surfactants such as alkyl sulfates having a chain length of 8 to 18 carbon atoms, alkyl or alkylaryl ether sulfates having 8 to 18 carbon atoms in the hydrophobic radical and up to 60 ethylene oxide or propylene oxide units, alkyl- or alkylarylsulfonates having 8 to 18 carbon atoms, esters and monoesters of sulfosuccinic acid with monohydric alcohols or alkylphenols, and nonionic surfactants such as alkyl polyglycol ethers or alkylaryl polyglycol ethers having up to 60 ethylene oxide and/or propylene oxide units.

The monomers can be included in their entirety in the initial charge, metered in in their entirety, or included fractionally in the initial charge, with the remainder being metered in after the polymerization has been initiated. The metered feeds can be conducted separately (in both space and time), or the components to be metered can be metered in with some or all of them being in preemulsified form.

Following substantial inclusion of polymerization, it is possible to carry out post-polymerization using known methods for the purpose of removing residual monomers, for example by means for example of a post-polymerization initiated with redox catalysts. Volatile residual monomers can also be removed by means of distillation, preferably under reduced pressure, and if desired, together with the passage of inert entraining gases such as air, nitrogen or water vapor through or over the reaction product.

The silicone-containing polymers find application in numerous areas of industry:

in plastics processing and modifying as additives for enhancing the property profile, such as for impact modification and for enhancing low-temperature impact strength; as additives for lubricity (slip agents) and release properties in polymers; as compatibilizers for polymer blends; as additives in silicone elastomer formulations, for example for increasing vapor barrier properties or enhancing and/or modifying the property profile; as additives for increasing the temperature stability of plastics and elastomers in the automotive industry, for example, in the near-engine area; and as PVC foam stabilizers;

in molding production and coating as seals, compression moldings, extruded profiles of high temperature stability, cable coatings, insulating coatings, and as an impregnating coating;

in the paint industry as coatings additives for reducing brittleness, for increasing the hydrophobicity of coatings, for extending the temperature range, and as a binder additive and adhesion promoter;

in architectural preservation, preferably in dispersion form, as a hydrophobicizing binder for paints and coatings; in organic solution as an impregnant for surfaces, and as a stock water repellency agent in brickmaking, plasterboard, cement fiberboard;

in the textile industry for textile finishing, textile coating, fiber treatment, textile and fiber hydrophobicization, fiber binders for nonwovens, additives for imparting a soft hand, for water repellency, and for anticrease finishing;

in the paper industry for release paper coating (release coatings), preferably as a solution or dispersion, as toner additives, and as auxiliaries in paper coating.

Further applications include those as process auxiliaries; as antifoams and devolatilizers in, for example, the paper or textile industries; for wastewater treatment; as an additive in agrochemicals (crop protection); as high-melting mold release agents and form release agents having a better temperature profile than polyolefin waxes; for surface treatment; as a hydrophobicizing and film-forming ingredient of polishes, e.g., (household and automobile polishes), in cosmetology, in hairspray, hair gel, hair fixative, hair colorants, shampoo, and as an agent for imparting a desirable consistency to cosmetic creams and lotions.

The silicone-containing polymers can also be employed in typical areas of application for polymer dispersions and dispersion powders: for example, in chemical products for the construction industry, alone or in conjunction with hydraulically setting binders such as cements (e.g., Portland, aluminate, trass, slag, magnesia, and phosphate cements, gypsym, and waterglass; for the production of construction adhesives, especially tile adhesives and exterior insulation and finishing adhesives; for renders, filling compounds, trowel-applied flooring compounds, leveling compounds, non-shrink grouts, and jointing mortars; for paints; and also as binders for coating materials and adhesives or as coating materials and binders for textiles, fibers, wood and paper.

### EXAMPLES

### Example 1

(Emulsion Polymerization):

A mixture of 1,200 g of water, 65 g of aqueous acrylamide (30% by weight), 97 g of Melon (20% by weight), 39 g of methacrylic acid, 75 g of butyl acrylate, 314 g of methyl methacrylate, and 43 g of hydroperoxide-containing polysiloxane was homogenized for 15 minutes using an Ultraturrax® mixer. The emulsion obtained had a particle size of about 600 nm.

This emulsion was introduced into a thermostatable polymerization vessel 2 liters in size and was heated to 70° C. When it had reached this temperature, 37 g of ascorbic acid solution (5% strength) were added over the course of 2 h. The polymerization temperature was maintained at 70° C. to 75° C. by external cooling. After the end of the polymerization, the dispersion obtained was cooled, filtered, and discharged. The solids content was 31% and the particle size was about 600 nm.

The hydroperoxide-containing polysiloxane used was a polydimethylsiloxane with hydroperoxide-containing methylbutanol units, having a degree of polymerization of 30 to 40 and a ratio of dimethylsiloxane units to hydroperoxide-containing siloxane units of 3.5:1.

### Example 2

(Solution Polymerization):

A thermostatable polymerization vessel 1 liter in size was charged with 350 g of dry toluene. To this initial charge were added 43 g of the hydroperoxide-containing polysiloxane used in example 1, and 86 g of methyl methacrylate. The mixture was heated to 70° C. Subsequently 2.1 g of activator (C-101, Degussa) in solution in 6.5 g of toluene were metered in over the course of 30 min. The polymer solution was heated at 70° C. for a further 60 min and then cooled. The toluene was separated off by distillation and the residue was dried in a drying cabinet. This gave a white waxlike material or powder.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A silicone-containing addition polymer, coomprising the product obtained by free-radically initiated polymerization of ethylenically unsaturated monomers, wherein the polymerization is initiated employing an organopolysiloxane which contains at least one peroxide group —OOR¹ in which each R¹ independently is a hydrogen atom, or a monovalent C₁ to C₁₈ hydrocarbon radical or C₁ to C₁₈ acyl radical each of which is optionally substituted by cyano-, fluoro-, chloro-, bromo- or organopolysiloxane and each of which is optionally interrupted by one or more divalent radicals attached on both sides to carbon atoms and selected from the group consisting of —O—, —COO—, —OOC—, —CONR³—, —NR³CO—, and —CO—, where R³ is independently hydrogen or an optionally cyano-, fluoro-, chloro- or bromo-substituted C₁ to C₁₀ hydrocarbon radical.

2. The silicone-containing polymer of claim 1, wherein the peroxide-functional organopolysiloxane contains at least one unit of the general formula
YₐR_{b}SiO_{4-a-b/2} (I)
where Y is a group of the general formula
-A-CR²₂—OO—R¹ (II)
and each R is indpendently a hydrogen atom, a C₁ to C₁₂ alkoxy radical, hydroxyl radical, alkylglycol radical, or a monovalent, optionally cyano-, fluoro-, chloro- or bromo-substituted C₁ to C₁₈ hydrocarbon radical which may be interrupted by divalent radicals attached on both sides to carbon atoms and selected from the group consisting of —O—, —COO—, —OOC—, —CONR³—, —NR³CO— and —CO—, A is a chemical bond or a divalent, optionally cyano-, fluoro-, chloro- or bromo-substituted C₁ to C₁₈ hydrocarbon radical, R¹ is a hydrogen atom, or a monovalent C₁ to C₁₈ hydrocarbon radical or C₁ to C₁₈ acyl radical each of which may be substituted by cyano-, fluoro-, chloro-, bromo- or organopolysiloxane and each of which is optionally interrupted by one or more divalent radicals attached on both sides to carbon atoms and selected from the group consisting of —O—, —COO—, —OOC—, —CONR³—, —NR³CO— and —CO—,
R² is an optionally cyano-, fluoro-, chloro- or bromo-substituted C₁ to C₁₀ hydrocarbon radical,
R³ is hydrogen or R², and
where
a=1, 2 or 3,
b=0, 1 or 2, and
a+b=1, 2 or 3.

3. The silicone-containing polymer of claim 1, wherein R is a hydrogen atom, a C₁ to C₁₂ alkoxy radical, or a C₁ to C₁₈ hydrocarbon radical, A is a chemical bond or a divalent C₁ to C₁₈ hydrocarbon radical, R¹ is a hydrogen atom, and R² is a C₁ to C₁₀ hydrocarbon radical.

4. The silicone-containing polymer of claim 1, wherein the peroxide-functional organopolysiloxane contains 20 to 40 units of the general formula (I).

5. The silicone-containing polymer of claim 1, wherein the molar ratio of siloxane units bearing a peroxide group —OOR¹ to the remaining siloxane units is from 1:10 to 1:1.

6. The silicone-containing polymer of claim 1, wherein the peroxide-functional organopolysiloxane contains terminal peroxide groups —OOR¹.

7. The silicone-containing polymer of claim 1, wherein the peroxide-functional organopolysiloxane is an organopolydialkylsiloxane having peroxide units attached via alkylene units along in the chain and/or terminally at the chain end.

8. A process for preparing the silicone-containing addition polymer of claim 1, comprising polymerizing by free-radically initiated polymerization, one or more ethylenically unsaturated monomers, wherein at least one free radical polymerization initiator comprises an organopolysiloxane which bears at least one peroxide group —OOR¹, where R¹ is independently a hydrogen atom, or a monovalent C₁ to C₁₈ hydrocarbon radical or C₁ to C₁₈ acyl radical each of which is optionally substituted by cyano-, fluoro-, chloro-, bromo- or organopolysiloxane and each of which may be interrupted by one or more divalent radicals attached on both sides to carbon atoms and selected from the group consisting of —O—, —COO—, —OOC—, —CONR³—, —NR³CO— and —CO—, where R³ is independently hydrogen or an optionally cyano-, fluoro-, chloro- or bromo-substituted C₁ to C₁₀ hydrocarbon radical.

9. The process of claim 8, wherein the step of polymerizing is a bulk, solution, or mini-emulsion polymerization.

10. In a composition wherein a property profile is modified by the addition of a polymer, the improvement comprising selecting as at least one polymer, the silicone polymer of claim 1.

11. The composition of claim 10 which is a plastics composition.

12. The composition of claim 10 which is a coating.

13. The composition of claim 10 which is a paint or architectural coating.

14. The composition of claim 10 which is a cosmetic composition.

15. The composition of claim 10 which is a hydraulically setting coating further comprising at least one inorganic binder selected from the group consisting of cements, plaster, and water glass.

16. A coating composition for application to a substrate, comprising the silicone-containing polymer of claim 1.

17. The coating composition of claim 16 which is an architectural coating.

18. The coating composition of claim 16 which is a release coating or binder, and the substrate is selected from plastic film, paper, textiles, and combinations thereof.
